(19) United States
(12) Patent Application Publication
(10) Pub. No.: US 2007/0071862 A1
(43) Pub. Date: Mar. 29, 2007

(54) Pasteurized uncooked batters and refrigerated ready-to-bake batters, and the methods of manufacturing

(76) Inventors: Cheryl R. Mitchell, Stockton, CA (US); Marian S. Schwartz, Stockton, CA (US)

Correspondence Address: The Halvorson Law Firm, P.C.;Ste 130, 1757 E. Baseline Rd., Gilbert, AZ, 85233, US

(21) Appl. No.: 11/241,449

(22) Filed: Sep. 29, 2005

(51) Int. Cl. A21D 10/00

(52) U.S. Cl. 426/549

(57) ABSTRACT

Described are uncooked batters that have been effectively pasteurized and have no gelatinized starch. These batters are characterized as having low viscosity, a water activity of greater than 0.90, the absence of an active leavening agent, and a total plate count of less than 1000 per gram. There are two methods of manufacturing these pasteurized uncooked batters. One method uses irradiated flour and sterile aqueous liquid to make a pasteurized flour slurry; the other method uses a process of treating the whole grain at temperature and time conditions such that the exterior of grain is pasteurized followed by wet milling of the whole grain in a sterile aqueous liquid such that the slurry passes through a 20 mesh screen. In both methods, the farinaceous material remains uncooked and the starch has not been gelatinized. The pasteurized aqueous flour slurries, are then added to the pasteurized remaining ingredients of the batter in a sterile environment. Refrigerated Ready-to-Bake batters can be made by the addition of gas upon dispensing the batter from a container having the batter and a compressed gas such as carbon dioxide, nitrous oxide, or nitrogen.

### BACKGROUND

Prior art teaches that in the preparation of ready-to-bake batters a chemical leavening system or leavening agent is required for the successful baking of the product. Conventional chemical leavening agents are ineffective in a refrigerated batter product since the leavening acid and base react prematurely (Joslin, U.S. Pat. No. 2,810,650). Instead of conventional chemical leavening agents the latter prior art, as well as others (Cochran), teach the use of high temperature leavening acids such as dicalcium phosphate dihydrate, which are active at temperatures greater than 160° F. and thereby only released during the baking process. While these high-temperature leavening agents prevent the early leavening of refrigerated batters, the delay in release of the leavening agent during the cooking process prevent the proper baking and formation of satisfactory grain and texture of the baked product. Additionally, these leavened batters are more susceptible to aerobic microorganisms making them even more susceptible to microbiological spoilage.

Going et al. (U.S. Pat. No. 3,021,220) discloses a culinary batter without a leavening agent capable of being stored for extended periods of time without refrigeration. Going heat pasteurized his unleavened batter by holding it at temperatures between 180° F. and 200° F. for periods of from 8 to 10 minutes, cooling said batter to 140° F. and then acidifying with a substantial amount of acid, 30 to 65 milliequivalents per 1000 gram of batter slurry. Going preferably used an acid that possessed anti-microbial properties, and, if the acid did not possess this property, then a microbiological inhibitor was added to retard microbiological growth. Going found that temperatures below 180° F. and a times of less than 8 minutes were not sufficient to stabilize the batter microbiologically and produce a batter having good “keeping qualities”.

Additionally, Going teaches that the leavening agent was to be added by the ultimate consumer just prior to baking. The pasteurization temperatures claimed by Going produce an extremely thick batter having very high viscosity caused by the gelatinization of starches at those temperatures. It would be expected by one skilled in the art that a thick viscous batter could easily entrain the gas of a leavening agents. Due to the relative ease of distribution by mixing of chemical leavening agents throughout the viscous batter, the resulting gas produced from the leavening agents are evenly dispersed as well.

Going also teaches that other sources of gas such as compressed carbon dioxide or nitrous oxide may be added to the batter both as a leavening agent and a propellant. However, the viscous nature of the batter itself, while effectively being able to “trap” the gas, does not readily and evenly incorporate the gas in such a way to produce a batter having an even distribution of entrained small gas bubbles throughout the batter as is produced by chemical leavening agents. Also, the viscosity of the batter severely limits any practical method that could be used to evenly incorporate compressed gas.

Hans (U.S. Pat. No. 3,620,763) discloses a refrigerated batter that is chemically leavened and may be packaged in a container suitable to hold the pressure created by the chemical leavening agent (10-25 psi). The batter has added to it a polysaccharide hydrophobic film former such as cellulose or a cellulose derivative that effectively stabilizes the batter against the coalescence of gas and migration and syneresis of water when stored under refrigerated conditions.

Narayanaswamy et al. (U.S. Pat. No. 6,228,403) teaches a shelf stable brownie batter that was packed in a container substantially unpressurized but having an atmosphere of less than 4% residual oxygen and a leavening system consisting of an inert gas such as carbon dioxide or nitrous oxide disposed within the container and within the batter itself. The stability of the batter and package is due to the limited oxygen in the package and the batter having a water activity of less than 0.85.

Pedrick et al. (U.S. Pat. No. 6,787,175 B2) teaches the use of encapsulated leavening agents such that the leavening agent is not released and therefore does not react under refrigerated storage conditions. Additionally, and more importantly, the encapsulated leavening agent allegedly does not release during high temperature short time processing (280° F. to 310° F.) necessary for the microbial stabilization of the batter. After processing, the batter is then cooled, packaged, and stored under refrigerated conditions for extended periods of time. According to this patent the leavening agent was only released at the time of baking of the batter.

It is known by those skilled in the art, that heating of batters containing aqueous solutions of farinaceous material such as wheat flour, starch, oat flours, rice flours, and the like, with or without leavening agents, to temperatures in excess of 120° F., causes severe and unacceptable functional changes in the components in the batter as noted by Hans above. For example, the starch in the flour begins to gelatinize and the proteins in the whole eggs, egg whites, or egg yolks, as well as the proteins in milk, begin to react or coagulate undesirably at temperatures in excess of 120° F. thereby resulting in viscous batters. These viscous batters are not only difficult to process and package but, as taught by Hans, unless acidified, that upon storage and baking, do not result in a baked good having the same volume, texture, and grain of the baked product as compared to baked products made from freshly prepared batters that are not subjected to any form of heating other than the baking process itself.

It is also known that food materials must first be at least pasteurized prior to packaging in order to prevent microbial growth and extend storage life. Foods having a water activity of below 0.85 are considered shelf stable and do not require refrigerated storage. Foods having a pH below 4.6 are considered high acid and do not require the same heat treatment as those foods having a higher pH as long as they are kept refrigerated. The most common means of pasteurization or sterilization of food materials has been by the use of specific time and temperature combinations and referred to as a thermal process. Other methods of pasteurization include irradiation, high pressure, electroheating, and microwave irradiation.

Packaging of ready-to-bake refrigerated batters have included for the most part pressurized containers which can hold the pressure resulting from the active leavening agents and the release of carbon dioxide creating pressure. It has been recognized by those skilled in the art, that carbon dioxide by itself as well as other inert gases such as nitrous oxide, may be incorporated into thickened or cooked batter as a leavening agent.

Certain foods are currently available using aerosol can technology. The most popular of which is whipped cream toppings. In the latter case, a smooth, creamy, low viscosity liquid is first pasteurized and put in a can to which is added compressed gas. Upon dispensing of the gas from the can, the gas is incorporated into this low viscosity liquid making it frothy or foamy. It is understood by those skilled in the art, that certain food ingredients such as dairy cream or egg whites, can readily incorporate and hold air bubbles when whipped vigorously with air. Consequently, it is not surprising that when placed in an aerosol type can, that these products easily incorporate the propellant air when dispensed from a container. Similarly, since it is known that uncooked batters with leavening agents incorporate the gas of the leavening agent, that these same batters could incorporate the compressed gas to form a leavened batter upon dispensing. However, the critical feature is the need for microbiological stability and shelf stability of the uncooked batter such that the batter can be distributed commercially via the refrigerated market. Up until now, pasteurized batters resulted in cooked batters having gelatinized starch and increased viscosities. These batters of increased viscosities are too thick to be dispensed or incorporate the propellant gas under the normal pressures associated with whipped cream type dispensing systems.

It is highly desirable, in order to achieve an economic and practical distribution of refrigerated food products, to have sufficient microbiological stability such that the food material has a shelf life of at least 45 days. In order to achieve this microbiological stability, most food products are subjected to a heat process that effectively pasteurizes the food product and reduces the total plate count substantially and therefore increases the refrigerated shelf life of the product. In the case of milk or milk products, temperatures may be readily used that are sufficient to pasteurize but not destroy the functionality of the milk proteins and ability to whip and entrap gas bubbles. Methods of pasteurizing egg whites have recently been developed that also preserve the functionality of the eggs. However, the heat treatment of aqueous farinaceous material sufficient to pasteurize the aqueous farinaceous slurry, results in the gelatinization of the farinaceous material and an undesirable increase in viscosity.

“Batter” as used herein refers to a food product that typically contain flour, water, salt, sweetener, and optionally fat, and eggs as ingredients and are a starch batter based composition. A batter cooks into a soft, moist and sometimes crumbly product. A batter is typically prepared by blending, creaming, stirring or whipping and is generally thin enough to pour, or scoop or squeeze out of a container. Batters of this type may be refrigerated for only a very short time and are not considered microbiologically stable due to the high microbiological load of the raw ingredients. In general, spoilage of the batter begins to occur after one week of refrigeration. Some microbiological stability is gained upon cooking of these batters in excess of 150° F., which gelatinizes the farinaceous matter and makes for a very viscous batter that is no longer thin enough to pour.

### SUMMARY OF THE INVENTION

It is an object of the invention to provide pasteurized uncooked batters. These pasteurized uncooked batters being further characterized as having (a) the absence of gelatinized starch; (b) no active leavening agents; (c) having a water activity greater than 0.90; (d) having no required added antimicrobial agents; (e) having a pH without added acids of greater than 4.5, and most importantly, (f) having a microbiological stability such that the shelf-life of the refrigerated batter is greater than 45 days.

It is another object of this invention to manufacture such pasteurized uncooked batters by first subjecting the flour to irradiation sufficient to sterilize the flour and then combining in a sterile environment this flour with (a) pasteurized eggs that have not been subjected to heat sufficient to denature the proteins, and (b) the remaining batter ingredients that have been pasteurized by thermal processing methods.

It is also an object of this invention to manufacture such pasteurized uncooked batters by first subjecting whole grains to thermal time and temperature conditions sufficient to sterilize the outer portion of the grain and yet not sufficient to gelatinize the farinaceous material, cooling the grain and then milling the grain in an aqueous environment to create a grain slurry that passes through a 20 mesh screen, and then combining in a sterile environment this grain slurry with (a) pasteurized eggs that have not been subjected to heat sufficient to denature the proteins, and (b) any remaining batter ingredients that have been pasteurized by thermal processing methods.

It is yet another object to use a gas such as carbon dioxide, nitrous oxide, nitrogen, or combination thereof, as the leavening agent in the pasteurized uncooked batters of this invention.

It is a further object to provide refrigerated ready-to-bake batters having refrigerated shelf stability of greater than 45 days, by placing the pasteurized uncooked batters of this invention in a container that can be pressurized with a gas such that the gas is readily incorporated into the batter at the time it is dispensed from the can providing leavening to these pasteurized uncooked batters.

It is yet another object to use a chemical leavening agent that is active at temperatures between 120° F. and 150° F. in refrigerated ready-to-bake pasteurized uncooked batters.

It is a further object to provide refrigerated ready-to-bake batters having refrigerated shelf stability of greater than 45 days by placing the pasteurized uncooked refrigerated batters of this invention and containing a chemical leavening agent that is active at temperatures between 120° F. and 150° F. in any container suitable for refrigerated distribution without having a requirement that the container be pressurized.

It is the ultimate object of this invention to provide ready-to-bake pasteurized uncooked refrigerated batters having a refrigerated shelf life in excess of 45 days and are packaged in such a way that no further mixing or blending on the part of the consumer is required and after baking, the resulting baked good demonstrates acceptable volume, texture, and grain.

It has been found that uncooked batters can be effectively pasteurized without subjecting the batter, and specifically the farinaceous and egg material of the batter, to thermal processing conditions that would gelatinize the farinaceous material or denature the proteins of the eggs. By combining, in a sterile environment, irradiated flour having a total plate count (TPC) of less than 500 per gram of flour, and more preferably less than one, in combination if desired with pasteurized eggs having all the functional properties of the eggs and having a TPC of less than 500 per gram, and preferably less than 1, together with the remaining batter ingredients which have been thermally processed to a TPC of less than 500 per gram, and preferably less than 1, a pasteurized uncooked batter results that has all of the characterizing features of the pasteurized uncooked batters of this invention including refrigerated stability of more than 45 days. Also, combining, in a sterile environment, an aqueous grain flour slurry prepared by first subjecting the whole grain to temperatures in excess of 180° F. for periods of less than 5 minutes, so that no starch is gelatinized, the grain immediately cooled and blended with sterile water to form an aqueous slurry that is then milled in a sterile mill; that this slurry when combined in a sterile environment with pasteurized eggs having all the functional properties of the eggs and having a TPC of less than 500 per gram, and preferably less than 1, together with the remaining batter ingredients which have been thermally processed to a TPC of less than 500 per gram, and more preferably less than 1, results in a pasteurized uncooked batter that has all the characterizing features of the pasteurized uncooked batters of this invention including refrigerated stability of more than 45 days.

Unexpectedly, it was found that these uncooked and yet pasteurized refrigerated batters that are not gelatinized and have a refrigerated shelf life in excess of 45 days, could be sufficiently and evenly leavened with compressed gas such as carbon dioxide, nitrous oxide, nitrogen, and the like, utilizing commercially available Whipped Topping dispensing systems, without significant modifications of the can or process. The resulting ready-to-bake pasteurized uncooked batter products produced a batter that when baked had very acceptable volume, texture, and grain as compared to a traditionally mixed and baked product. The resulting pasteurized uncooked batters, upon being dispensed, produced a distinctive foamy batter material having an even distribution of very small gas bubbles. Unexpectedly, in-spite of the irradiation treatment of the flour or the use of heat treated and milled whole grain slurry, the batter was readily dispensed through this pressurized can system, and the gas was evenly dispersed and entrained within the batter to produce a relatively stable “foam” sufficient to hold its shape while initiating the cooking process.

Additionally it was discovered that these pasteurized uncooked refrigerated batters could readily incorporate a chemical leavening agent, without any changes in viscosity, as long as that chemical leavening agent was active between 120° F. and 150° F. These pasteurized ready-to-bake uncooked batters could then be made available in un-pressurized refrigerated containers similar to those used for refrigerated milk.

We also found that there was an additional advantage of these pasteurized uncooked batters that do not contain “active” leavening agents. The absence of gas distributed through the batter prior to dispensing, or having a chemical leavening agent that was not active at refrigerated temperatures, in the presence of farinaceous material that has not been gelatinized, does not result in a concern with regard to the coalescence of gas and migration and syneresis of water when stored under refrigerated conditions.

In summary, the present invention relates to pasteurized uncooked batters that are suitable for making ready-to-bake batters and are microbiologically stable for refrigerated distribution for periods of greater than 45 days in either whipped cream type cans or refrigerated unpressurized cartons.

Now as set forth in the objectives above, we will set forth below and describe in full detail, a method for the production of the flour component of batter, such that the flour component has a substantially reduced microbiological load as compared with raw flour normally utilized in the manufacture of batters, and amazingly, has the viscosity of a flour slurry that has not been subjected to any heat. The blend of this “pasteurized” flour stream with low temperature fully functional pasteurized eggs, in combination with the other batter ingredients such as milk, fat, and sugar which have been separately pasteurized by traditional thermal methods, produces a low gelatinization and microbiologically stable batter that need not be subjected to any further heat process to pasteurize or otherwise stabilize the batter. Additionally, ready-to-bake batters, (or those batters to which a leavening agent has been added), which utilize the microbiologically stable uncooked refrigerated batter can be made and result in baked goods having acceptable volume, texture, and grain.

Batter products suitable for the processes of this invention include: cakes, rolls, biscuits, shortbread fritters, cornbread, pancakes, crepes, muffins, cookies, doughnuts, dumplings, quickbreads, puffed snacks, souffles and other similar products.

The novel features that are considered characteristic of the invention are set forth with particularity in the appended claims. The invention itself, however, both as to its structure and its operation together with the additional objects and advantages thereof will best be understood from the following description of the preferred embodiment of the present invention. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments of the invention is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### DESCRIPTION OF THE DRAWINGS

FIG. 1 illustrates one embodiment for dispensing the present invention.

FIG. 2A is a cutaway view of a preferred nozzle for dispensing the preferred embodiment of the present invention.

FIG. 2B illustrates how the nozzle is activated.

FIG. 3A is an exploded view of a pressurizing can according to the present invention.

FIG. 3B illustrates assembly of the pressurizing can according to the present invention.

FIG. 3C illustrates the assembled can according to the present invention.

FIG. 3D illustrates a closer view of the use of the pressurizing can according to the present invention.

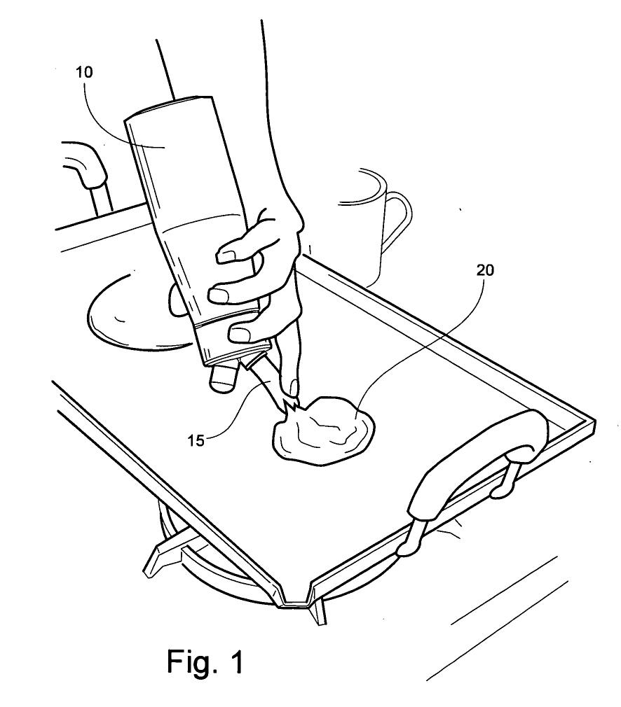

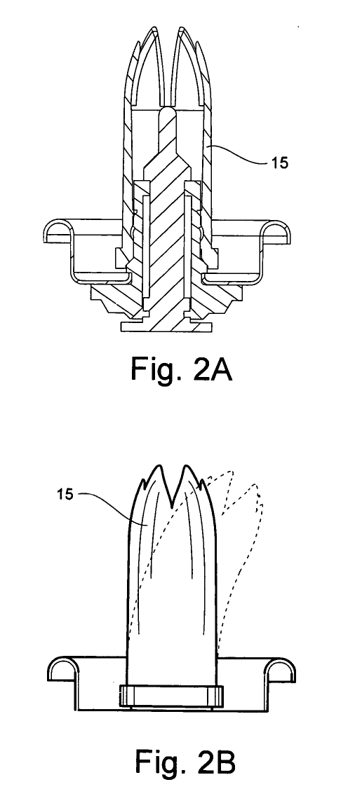

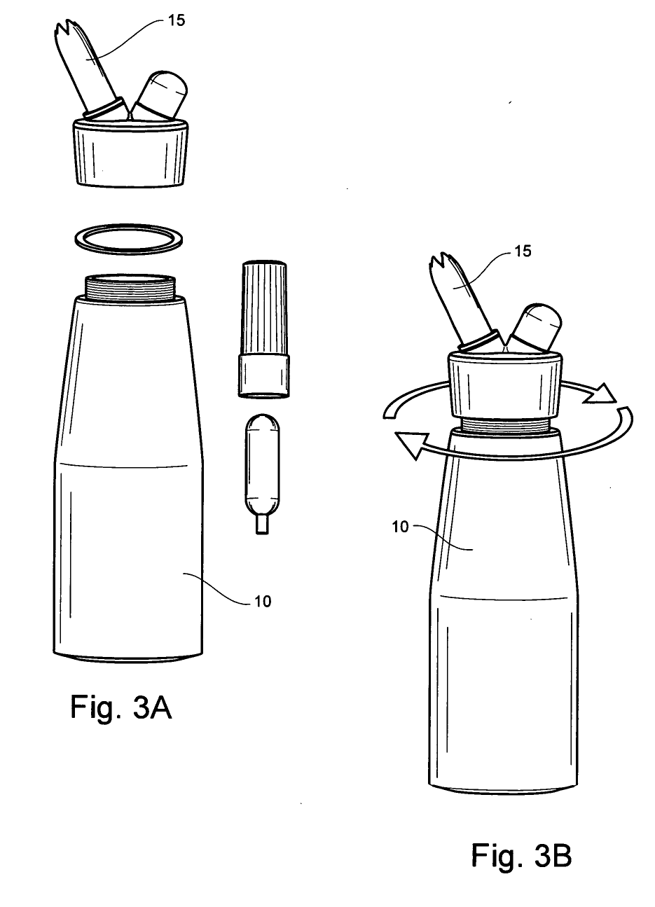

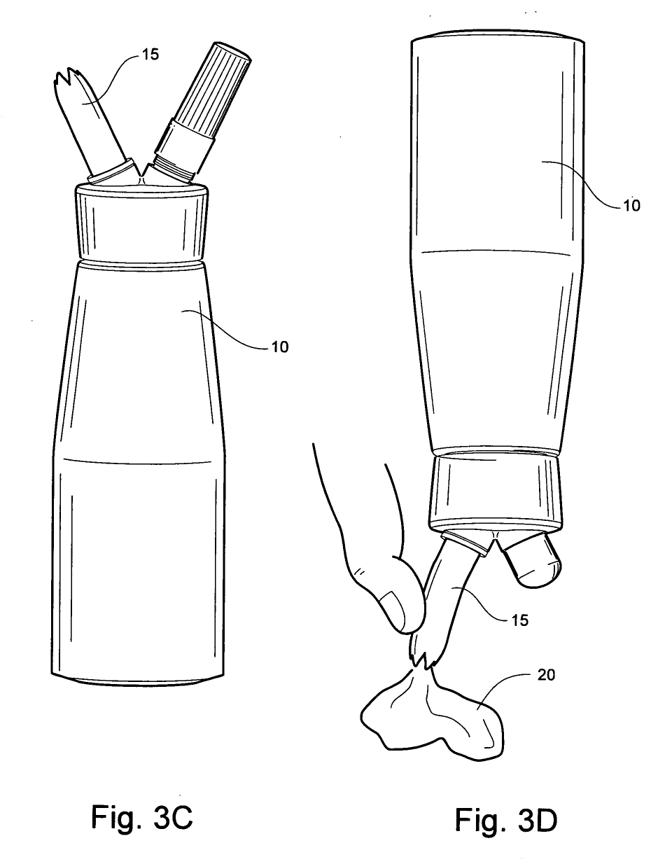

### DESCRIPTION OF THE PREFERRED EMBODIMENT

Raw flours such as those derived from wheat, corn, barley, rye, rice or any other similar farinaceous material, as obtained from flour mills, normally contain high total plate counts on the order of 10,000 to 50,000 per gram of flour. These flours when incorporated into a refrigerated aqueous slurry having a water activity of greater than 0.90, and a pH of greater than 4.5 would result in the microbiological spoilage of the slurry in less than one week under typical refrigerated storage conditions. The present invention details two effective methods for the pasteurization of these flours without heating and causing gelatinization of the flour slurry, such that the resulting flour slurry has total plate counts of less than 1000 and preferably less than 1. The pasteurized flour slurries of this invention may subsequently be used in the making of batters having a water activity of greater than 0.9, a pH of greater than 4.5 which is characteristic of the flour slurry, and the absence of gelatinized starch and therefore a Bostwick consistency of greater than 5 cm per 30 seconds at 40° F.

The first method involves the irradiation of the flour and subjecting said flour having a high plate count to radiation sufficient to sterilize the flour without causing undue changes in the taste of the flour. It is known by those skilled in the art of irradiation of grains, that 30 kilograys of radiation is more than sufficient to kill all the microorganisms found in the flour without producing significant changes in flavor of the flour. Aqueous slurries of this flour made with sterile water, demonstrate a TPC of less than 1 per gram. Similar slurries made with irradiated flour having a treatment of 10 kilograys and then blended with sterile water produced slurries having reduced counts below 500 TPC per gram. These flour slurries, when combined with other batter components such as pasteurized eggs, milk, sugars, and oil that had first been pasteurized prior to blending with the flour, produced the pasteurized uncooked refrigerated batter of this invention.

Since irradiation of food ingredients is not commonly accepted by the consumers, an alternative method to produce pasteurized flour slurries was highly desirable. Alternately, by starting with whole undivided grain, and subjecting the whole undivided grain to direct steam or directly by contact with hot water, followed by immediate cooling and milling, a divided whole grain flour slurry could be produced that did not contain gelatinized starch. The whole undivided grain was first subjected to temperatures in excess of 180° F., and more preferably to temperatures greater than 212° F., and even more preferred, to temperatures of 230° F., for preferred time periods of less than 5 minutes for temperatures of 180° F. and about 15 seconds for temperatures of 230° F. Different combinations of heat and temperatures were used and the resultant whole grain slurry plated to determine the TPC. Results of these trials are provided in Table 1.

TABLE 1
Wheat Grain Pasteurization Conditions

| Sample | Pasteurization Treatment | CFU/Gram |
|---|---|---|
| Raw Spring Wheat Flour | None | 27,000 |
| Raw Hard Red Winter Wheat | None | 14,000 |
| Pearled Soft White Wheat | None | 43,000 |
| Raw Hard Red Winter Wheat | Heat - 180° F. | <10 |
| | for 3 minutes | |
| Hard Red Winter Wheat | Heat - 212° F. | <10 |
| | for 1 minute | |
| Hard Red Winter Wheat | Heat - 230° F. | <10 |
| | for 15 seconds | |
| Hard Red Winter Wheat | Irradiated at 10 Kilograys | 20 |
| Hard Red Winter Wheat | Irradiated at 30 Kilograys | <10 |

It was found that the combination of heat and time was sufficient to sterilize the outer component of the grain without resulting in the gelatinization of the inner starch materials of the grain. Immediately after subjecting the grain to this heat treatment, we then cooled the grain to between 35° F. and 120° F., more preferably around 40° F., the grain being added to cold sterile aqueous liquid of about 33° F. to 45° F. and more preferably 35° F., the aqueous cold pasteurized slurry being further subjected to a wet milling process such that the grain is reduced in size similar to the size found in an aqueous slurry of dry milled grain flour and water and sufficiently reduced in size to have 100% of the milled slurry pass through a 20 mesh screen. The latter process of heating the whole grain, cooling the grain and wet milling, produced an aqueous flour slurry having total plate counts below one. The wet milling process being conducted in a closed environment such that the environment could be pre-sterilized and subsequently did not contribute a source of microbiological contamination to the commercially sterile aqueous slurry as it was being prepared.

On a production scale, a wet rotor stator type mill, such as the Silverson, is preferred. These mills, when placed in a linear sequence, readily provide the milling of the whole grain sufficient to produce a particle size distribution such that the largest particle would pass through 20 to 100 mesh screen and more preferably a 20 mesh screen. Additionally, these mills could be sterilized such they did not cause microbiological contamination to the slurry. These pasteurized and milled whole grains that are retained in a sterile environment, are one component of the remaining, individually pasteurized components, necessary to formulate and mix blend in a sterile environment, the pasteurized uncooked batter of this patent.

To this pasteurized uncooked grain slurry may be then added in a sterile or microbiologically controlled environment the additional components such as pasteurized eggs, pasteurized soy proteins or the like. Typically these pasteurized components are commercially available in sterile containers. When using eggs, the eggs retain the functionality of the proteins and the proteins are not coagulated or otherwise degraded. The pasteurized eggs, which retain the functionality of the whole eggs, egg whites, and egg yolks, may be purchased commercially in sterile bags. The commercially pasteurized eggs possess microbiological stability of at least 88 days. After processing and packaging, they can be optionally frozen. The advantage of immediately freezing the pasteurized eggs is that only after the eggs are defrosted under refrigerated conditions, does the refrigerated shelf life start. For commercial applications, it is then possible to defrost the frozen eggs when the processor is ready to transfer these eggs under sterile conditions to the other components of the pasteurized uncooked batter that is being made.

The thermal processing of the residual ingredients necessary to complete the desired formulation uses the methods typical of those skilled in the art for thermal processing. Typically, a solution of water, milk, or milk solids, sugars, oils and flavors constitute the bulk of the remaining ingredients that need to be separately processed and pasteurized by thermal process. The selected remaining ingredients are blended, and heated at least 180° F. and as high as 295° F. for periods of from 5 minutes to 4 seconds respectively. The selection of time and temperature combinations being made such that these remaining ingredients in liquid form, are the third component of the pasteurized uncooked batters and have a desired TPC of less than 1 per gram. These pasteurized liquid ingredients are then immediately chilled under sterile conditions to temperatures below 40° F. and preferably 35° F. and held under sterile conditions.

The liquid ingredients of the batter may be necessary to provide sufficient liquid to suspend the grain and flour material so that it is easily pump-able and flows as a liquid. Preferably, the ratio of the aqueous liquid ingredient to flour or whole grain should be at least 1.5 to 1, and more preferably 2 to 1 to allow for the pumpability of solids and water. Batters of this invention preferably were found to have a Bostwick consistency of 5 to 20 cm per 30 seconds or more preferably greater than 5 cm per 30 seconds. Additionally, the preferred water activity was found to be in excess of 0.90 but more preferably in excess of 0.99. There is an additional advantage of adding the egg component prior to the milling of the pasteurized grain material in that because of the rotor stator grinding action on the grain, the eggs are more readily homogenized along with the other components when passing through the mills. The order of addition of the components is not significant as compared to making sure there are sufficient liquids necessary to mill the pasteurized grain.

The now refrigerated pasteurized uncooked batter 20 may now, under sterile conditions, be transferred to a can 10 similar to those used for whipped cream. The can 10 is then pressurized to between 150 and 160 psi, which is typical for whipped cream, with a gas component that has been passed through a 0.2 micron filter sufficient to sterilize the gas. The pressure of gas chosen may be based on the desired pressure and foam desired in the resulting batter when dispensed. The batter 20 is dispensed from the can 10 through a nozzle 15 located at one end of the can 10. In the case of the batters of this invention having a Bostwick consistency of between 19 and 20 cm per 30 seconds, the can 10 was pressurized at between 150 and 160 psi with a dispensing gas pressure of 135 psi after two days. The canned pressurized batter is then ready for commercial refrigerated distribution at temperatures below 40° F. and has a shelf life in excess of 45 days and more preferably, a shelf life of 60 days and even more preferably, greater than 90 days. The pasteurized refrigerated uncooked batter may now be considered a Ready-to-bake batter since the consumer need only dispense the canned batter for use.

The refrigerated pasteurized uncooked batter may also have added, under sterile conditions, a chemical leavening agent that has also been pre-pasteurized and stored under refrigerated conditions. This pasteurized chemical leavening agent has the additional property of activating at above 50° F. and more preferably below 140° F. such that the agent is released rapidly providing immediate leavening upon heating or baking the batter. The chemical leavening may be used alone, or in combination with the leavening of the gas in the compressed can 10. If the chemical leavening is used alone in the pasteurized uncooked batter, the batter can then be filled in a suitable sterile container under sterile conditions, maintaining the temperature below 40° F. so that the chemical leavening agent is not active. Since the leavening agent is not active at refrigerated temperatures, there is no need for a pressurized container and a suitable refrigerated container such as a flexible gable top carton (similar to a milk carton), is all that is required. This pasteurized uncooked refrigerated batter containing a chemical leavening agent, is now considered a ready-to-bake refrigerated batter since the consumer needs to only pour and bake.

Pasteurized uncooked refrigerated batters and ready-to-bake batter formulations prepared by the methods of this invention are suitable for the preparation of cakes, rolls, biscuits, shortbread fritters, cornbread, pancakes, crepes, muffins, cookies, doughnuts, dumplings, quickbreads, puffed snacks, souffles, cupcakes, and other similar products.

Examples 1 through 6 below provide batters, their formulations, and the methods of making pasteurized uncooked batters in an effort to further describe and illustrate the practice of this invention without limiting the scope of the invention.

### EXAMPLE 1

### Pasteurized Uncooked Wheat Flour Slurry—Irradiated Flour

175 grams Wheat Flour that had been irradiated to 30 Kilograys was transferred from its sterile container in a sterile environment to a blender that had been sterilized. To this blender was added 263 grams sterile water and the flour was milled so as to produce a sterile uncooked wheat flour slurry having a pH of 6.3.

### EXAMPLE 2

### Pasteurized Uncooked Pancake Batter Made with Irradiated Flour

To 438 grams of the Sterile Wheat Flour Slurry from Example 1 was added in a sterile environment, a refrigerated and pasteurized blend containing 22 grams non-fat dry milk, 6.25 grams of sugar, 1.75 grams of sodium chloride, 6.15 grams of canola oil, 0.79 grams of Sodium Stearoyl Lactylate, and 23.75 gram whole eggs. The resulting batter had a Bostwick consistency of 19.6 cm/30 sec., a water activity of 0.99, and a pH of 6.2. The resulting batter had a total plate count of less than 10.

### EXAMPLE 3

### Pasteurized Uncooked Ready-to-Bake Pancake Batter Made with Irradiated Flour and Using Encapsulated Leavening Agent

To 500 gram of Example 2 above which was kept at a refrigerated temperature of 38° F., was added under sterile environment conditions, 5.0 grams of a pasteurized encapsulated Sodium Bicarbonate that had no free Sodium Bicarbonate upon being suspended in water nor did this bicarbonate leach out into aqueous solutions at temperatures below 50° F. The bicarbonate from this encapsulated leavening agent was readily released at temperatures above 90° F. After blending of the leavening agent into the pasteurized uncooked batter, the resulting Ready-to-Bake Batter having a water activity of 0.99 and a Bostwick consistency of 20 cm/30 sec, was filled into a standard milk carton container, sealed and kept refrigerated for 45 days. Cooking of the Ready-to-Bake batter on a 400° F. griddle for approximately 80 seconds on both sides, provided a satisfactory pancake of approximately ⅜ inch thickness and having the grain and texture anticipated for a pancake.

### EXAMPLE 4

### Pasteurized Uncooked Whole Wheat Flour Batter—Heat Pasteurized Wheat

The whole undivided wheat, weighed out to 159 grams as is basis, was first subjected in a closed stainless steel tube for 60 seconds to steam at ambient pressure (temperature of 212° F.). The contents of the tube was dispensed in a sterile environment directly into a sanitized blender containing a refrigerated (35° F.) pasteurized blend having a TPC of less than 10 and containing 278 grams of 2% milk, 23.8 grams water, 6.25 grams sugar, 0.75 grams sodium chloride, 6.15 grams canola oil, and 0.8 grams of Sodium Stearoyl Lactylate. This cold mixture was then ground in the sanitized Waring type blender until the slurry could readily pass through a 20 mesh screen. To this cold mixture was added 23.75 grams of pasteurized whole eggs that had been transferred under sterile conditions into the aforementioned blend. The batter was mixed until the eggs were well mixed. The resulting batter mixture containing the pasteurized whole wheat, pasteurized milk blend, and pasteurized eggs, produced a batter having a TPC count of less than 500 and having a Water Activity of 0.99. The Bostwick consistency of this batter was found to be 18 cm/30 sec.

### EXAMPLE 5

### Pasteurized Uncooked Ready-to-Bake Batter in Pressurized Can

400 grams of the refrigerated batter from Example 4 was placed into a pressurizable can similar to those used for whipped cream, having an empty volume of 22.3 ounces. The can was then pressurized using nitrous oxide such that the immediate pressure in the can was between 150 and 160 psi. After 45 days of refrigerated storage, the batter in the can was shaken about 30 times and then was dispensed from the can. The resulting leavened batter was frothy and white in appearance and was dispensed directly onto a griddle that had been preheated to 400° F. The frothy batter had a stiffness similar to a very thick milkshake. The resulting pancake was typical in appearance having a height of about ⅜ inch and had the texture and grain anticipated for pancakes. The taste was considered equal to or superior to the taste of freshly made pancakes.

### EXAMPLE 6

### Pasteurized Uncooked Ready-to-Bake Cupcake Batter

The following ingredients were first blended and creamed together to make a smooth slurry: 55.75 grams whole eggs, 120.8 grams sugar, 79 grams butter, 0.95 grams sodium chloride and 1.85 grams vanilla. This creamed egg slurry was then pasteurized at sufficient temperatures to reduce the TPC to less than 10 without denaturing the egg protein, which has been further protected by the fat and sugar present in the slurry composition. The pasteurized slurry is stored in an aseptic package at frozen temperatures until ready for use. Whole undivided wheat, weighed out to 93 grams as is basis, was first subjected in a closed stainless steel tube for 15 seconds to steam at pressure of 230 psi (temperature of 230° F.). The contents of the tube was dispensed in a sterile environment directly into a sanitized blender containing refrigerated (35° F.) Ultra High Temperature Short Time Processed 2% milk that had been transferred into a sanitized Waring type blender in a sterile environment. To this UHT processed refrigerated milk, was added the pasteurized egg slurry and the sterilized whole undivided wheat. The slurry was then ground with the Waring blender until all particles would pass through a 20 mesh screen. The resultant batter was found to have a Bostwick consistency of 10 cm/30 sec at 40° F., a water activity of 0.90, and a TPC of less than 10. 400 grams of the refrigerated batter was placed into a pressurizable can similar to those used for whipped cream, having an empty volume of 22.3 ounces. The can was then pressurized using nitrous oxide such that the immediate pressure in the can was between 150 and 160 psi. After 45 days of refrigerated storage, the batter in the can was shaken about 30 times and then was dispensed from the can. The resulting leavened batter was frothy in appearance, similar to a very thick milkshake, and was dispensed directly into cupcake pans with paper liners and immediately baked in a 350° F. pre-heated oven for 30 minutes. After baking, the cupcakes were cooled on a rack and tasted. The resulting cupcakes were typical in appearance and had the texture and grain anticipated for cupcakes. The taste was considered equal to or superior to the taste of freshly made cupcakes.

The preferred embodiment of the invention is described above in the Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A method for preparing a batter comprising the steps of combining whole grain that has been subjected to direct steam or hot water, immediate cooling, combination with sterile aqueous liquid, wet milling to produce a slurry without gelatinized starch, and combining with other batter components.

2. The method according to claim 1 wherein the step of subjecting the whole grain to direct steam or hot water raises the whole grain to temperatures greater than 180° F. for less than five minutes.

3. The method according to claim 1 wherein the step of subjecting the whole grain to direct steam or hot water raises the whole grain to temperatures greater than 212° F. for less than five minutes.

4. The method according to claim 1 wherein the step of subjecting the whole grain to direct steam or hot water raises the whole grain to temperatures greater than 230° F. for less than five minutes.

5. The method according to claim 1 wherein the batter has water activity greater than 0.90.

6. The method according to claim 2 wherein the batter has water activity greater than 0.90.

7. The method according to claim 3 wherein the batter has water activity greater than 0.90.

8. The method according to claim 4 wherein the batter has water activity greater than 0.90.

9. A method for dispensing the batter of claim 1 comprising the steps of adding a portion of the batter into a pressurizable can and pressurizing the can with a gas to a pressure sufficient to dispense the batter.

10. The method according to claim 9 wherein the gas acts as a leavening agent once the batter has been dispensed.

11. The method according to claim 9 where a chemical leavening agent that is activatable at temperatures between 50° F. and 140° F. is added to the batter prior to the step of adding the batter into the can.

12. The method according to claim 9 wherein the batter has water activity greater than 0.90.

13. The method according to claim 10 wherein the batter has water activity greater than 0.90.

14. The method according to claim 11 wherein the batter has water activity greater than 0.90.

15. A method for preparing a batter comprising the steps of combining whole grain that has been subjected to direct steam or hot water followed by immediate cooling, combination with sterile aqueous liquid, other batter components and wet milling to produce a slurry without gelatinized starch.

16. The method according to claim 15 wherein the step of subjecting the whole grain to direct steam or hot water raises the whole grain to temperatures greater than 180° F. for less than five minutes.

17. The method according to claim 15 wherein the step of subjecting the whole grain to direct steam or hot water raises the whole grain to temperatures greater than 212° F. for less than five minutes.

18. The method according to claim 15 wherein the step of subjecting the whole grain to direct steam or hot water raises the whole grain to temperatures greater than 230° F. for less than five minutes.

19. The method according to claim 15 wherein the batter has water activity greater than 0.90.

20. The method according to claim 16 wherein the batter has water activity greater than 0.90.

21. The method according to claim 17 wherein the batter has water activity greater than 0.90.

22. The method according to claim 18 wherein the batter has water activity greater than 0.90.

23. A method for dispensing the batter of claim 15 comprising the steps of adding a portion of the batter into a pressurizable can and pressurizing the can with a gas to a pressure sufficient to dispense the batter.

24. The method according to claim 23 wherein the gas acts as a leavening agent once the batter has been dispensed.

25. The method according to claim 23 where a chemical leavening agent that is activatable at temperatures between 50° F. and 150° F. is added to the batter prior to the step of adding the batter into the can.

26. The method according to claim 23 wherein the batter has water activity greater than 0.90.

27. The method according to claim 24 wherein the batter has water activity greater than 0.90.

28. The method according to claim 25 wherein the batter has water activity greater than 0.90.

29. A method for preparing a batter comprising the steps of irradiating flour for a time and intensity sufficient to sterilize the flour without causing undue changes in the taste of the flour, combining the irradiated flour with sterilized aqueous liquid to produce a slurry, and combining the slurry with other batter components.

30. The method according to claim 29 wherein the step of subjecting the flour to irradiation exposes the flour to 10 kilograys of radiation.

31. The method according to claim 29 wherein the step of subjecting the flour to irradiation exposes the flour to 20 kilograys of radiation.

32. The method according to claim 29 wherein the step of subjecting the flour to irradiation exposes the flour to 30 kilograys of radiation.

33. The method according to claim 29 wherein the batter has water activity greater than 0.90.

34. The method according to claim 30 wherein the batter has water activity greater than 0.90.

35. The method according to claim 31 wherein the batter has water activity greater than 0.90.

36. The method according to claim 32 wherein the batter has water activity greater than 0.90.

37. A method for dispensing the batter of claim 29 comprising the steps of adding a portion of the batter into a pressurizable can and pressurizing the can with a gas to a pressure sufficient to dispense the batter.

38. The method according to claim 37 wherein the gas acts as a leavening agent once the batter has been dispensed.

39. The method according to claim 37 where a chemical leavening agent that is activatable at temperatures between 50° F. and 140° F. is added to the batter prior to the step of adding the batter into the can.

40. The method according to claim 37 wherein the batter has water activity greater than 0.90.

41. The method according to claim 38 wherein the batter has water activity greater than 0.90.

42. The method according to claim 39 wherein the batter has water activity greater than 0.90.

43. A pasteurized uncooked batter comprising a batter having a viscosity consistent with the absence of gelatinized starch or a Bostwick consistency of greater than 18 cm/30 seconds; having no active leavening agents; having a water activity greater than 0.90; and having a Total Plate Count of less than 1000.

44. The batter according to claim 43 where the batter is prepared by combining whole grain that has been subjected to direct steam or hot water followed by immediate cooling, combination with sterile aqueous and wet milling to produce a slurry without gelatinized starch, with other batter components.

45. The method according to claim 44 wherein the step of subjecting the whole grain to direct steam or hot water raises the whole grain to temperatures greater than 180° F. for less than five minutes.

46. The method according to claim 44 wherein the step of subjecting the whole grain to direct steam or hot water raises the whole grain to temperatures greater than 212° F. for less than five minutes.

47. The method according to claim 44 wherein the step of subjecting the whole grain to direct steam or hot water raises the whole grain to temperatures greater than 230° F. for less than five minutes.

48. The batter according to claim 43 where the batter was prepared by combining whole grain that has been subjected to direct steam or hot water followed by immediate cooling, combination with sterile water, other batter components and wet milling to produce a slurry without gelatinized starch.

49. The method according to claim 48 wherein the step of subjecting the whole grain to direct steam or hot water raises the whole grain to temperatures greater than 180° F. for less than five minutes.

50. The method according to claim 48 wherein the step of subjecting the whole grain to direct steam or hot water raises the whole grain to temperatures greater than 212° F. for less than five minutes.

51. The method according to claim 48 wherein the step of subjecting the whole grain to direct steam or hot water raises the whole grain to temperatures greater than 230° F. for less than five minutes.

52. The batter according to claim 43 where the batter was prepared by irradiating flour for a time and intensity sufficient to sterilize the flour without causing undue changes in the taste of the flour, combining the irradiated flour with sterilized aqueous liquid to produce a slurry, and combining the slurry with other batter components.

53. A device for dispensing batter comprising a can containing an uncooked batter having a viscosity consistent with the absence of gelatinized starch or a Bostwick consistency of greater than 5 cm/30 seconds; having no active leavening agents; having a water activity greater than 0.90; and having a Total Plate Count of less than 1000, and a pressurizing gas, said can further comprising a nozzle for dispensing said uncooked batter.

54. A Refrigerated ready-to-bake batter comprising a batter having a viscosity consistent with the absence of gelatinized starch or a Bostwick consistency of greater than 5 cm/30 seconds; having a water activity greater than 0.90; having a Total Plate Count of less than 1000.

55. The batter according to claim 54 further comprising a leavening agent.
